(19) United States
(12) Patent Application Publication
(10) Pub. No.: US 2008/0159717 A1
(43) Pub. Date: Jul. 3, 2008

(54) DIGITAL IMAGE REPRODUCING APPARATUS AND METHOD OF FORWARD/REVERSE SEARCHING DIGITAL IMAGES

(75) Inventor: Jeong-Hoon Lee, Gwengju-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/839,837

(22) Filed: Aug. 16, 2007

(30) Foreign Application Priority Data
Dec. 29, 2006 (KR) 2006-138789

(51) Int. Cl. H04N 11/02; G06F 17/30; H04N 7/26

(52) U.S. Cl. 386/124; 375/240.01; 386/68; 707/6; 375/E07.027

(57) ABSTRACT

A digital image reproducing apparatus and a digital image forward/reverse searching method, in which the digital image reproducing apparatus includes: a decoder decoding digital video images; and a searching parameter setting unit for setting the searching parameters used to search the digital video images. The decoder decodes an essential frame that must be decoded that is decoded, and waits to receive a next process command from a user. The searching parameter includes at least one of a searching direction, a searching speed, a time code jump value, and the essential frame that must be decoded. The essential frame that must be decoded can be the last frame of the digital video images. Therefore, the frames that are not the key frames can be decoded during the searching process, and the searching process can be performed in a predetermined section, to thereby improve searching efficiency.

### CROSS-REFERENCE TO RELATED APPLICATION

This application claims the benefit of Korean Application No. 2006-138789, filed Dec. 29, 2006 in the Korean Intellectual Property Office, the disclosure of which is incorporated herein by reference.

### BACKGROUND OF THE INVENTION

1. Field of the Invention

Aspects of the present invention relate to a digital image reproducing apparatus, and more particularly, to a digital image reproducing apparatus to temporarily stop operation after displaying a certain image frame when the digital image is forward/reverse searched, and a method of forward/reverse searching digital images.

2. Description of the Related Art

Various apparatuses (such as video tape recorders, an integrated circuit such as a random access memory (RAM), optical discs such as a compact disc (CD), a digital versatile disc (DVD), or a video compact disc, and a hard disc drive) can be used to store a large amount of audio/video data. In particular, as digital image processing technology has developed, moving pictures having high image quality can be encoded in real-time and can be distributed by way of various digital media. The development of digital image processing technology has prompted the rapid distribution of digital camcorders. Also, users can create their own user created contents (UCC) using digital cameras or mobile phones. In addition, the users can share their UCC with a plurality of other users through blogs or Internet homepages. In particular, UCC sharing is rapidly becoming as widespread as still image sharing.

Along with the digital image processing technology, technology to fabricate large capacity storage media also has improved. CDs having storage capacities of 700 MB are not enough to store high quality video, and accordingly, DVDs having storage capacities of 4.7 GB are widely used. Movies in super video CD (SVCD)-format can be stored in the DVDs, and various additional functions can be added. Accordingly, DVDs are now mainly used.

However, DVDs are also unable to store high definition (HD)-level video. Therefore, HD-DVDs or Blu-ray discs to store HD-level video are being developed and products thereof are becoming more widespread. HD-DVD and Blu-ray discs have the storage capacities of approximately 24 GB, and can store information in one disc equivalent information that are stored in six DVD discs. The high-capacity disc type storage media is advantageous in terms of price. In addition, storage media having large storage capacities such as hard disc drives (HDDs) are also widely used. Due to the development of digital image processing technology and the development of high-capacity storage media, the users are not simply passive receivers of digital images any longer. Rather, the users can easily create their own UCC at low cost and within a short period of time.

However, it is not easy to search for a desired scene in digital videos, in particular, in the UCC. For example, in order to search for a certain portion desired by the user in a text document, the document can be easily searched by detecting a certain character string therein. However, it is difficult to apply the above search method to a search of still images of the digital videos. That is, in order to search for an image that includes a certain scene from a plurality of still images, various technologies (such as an edge detecting algorithm, vector analysis, and color processing) must be applied together, but reliability of a search result using the same is low. Moreover, it is difficult to automate the search for a certain digital image for the desired scene from among a plurality of digital images. Therefore, the user must play the digital video in a forward direction or a reverse direction to search for the certain image, even though such is time consuming.

FIGS. 1A and 1B are views illustrating a related art forward/reverse searching method. FIG. 1A shows the reverse searching method and FIG. 1B shows the forward searching method. In the related art method, the digital video includes frames that can be independently decoded and frames that are not independently decoded. The frames that can be independently decoded are referred to as key frames, intra frames, I frames, or instantaneous decoder refresh (IDR) frames. The frames that are not independently decoded are referred to as inter frames, P frames, or B frames, and are formed by using a differential value between the inter frames and the key frames. Reverse searching (or rewind (REW)) and forward searching (or fast forward (FF)) can be performed by decoding the key frames in the digital video and displaying the decoded key frames. An interval between the key frames can vary depending on the type of digital image contents, and are even changeable within a digital video file. Frame numbers are applied to the frames as shown in FIGS. 1A and 1B for convenience of explanation.

It is assumed that frames 0, 30, 60, and 90 illustrated in FIG. 1A, frames 210, 240, 270, and 300 illustrated in FIG. 1B are key frames, and the remaining frames therein are frames that cannot be decoded independently. The REW or FF function can be implemented by decoding the key frames accordingly. The key frames are decoded sequentially, periodically, or by using an acceleration function. That is, according to the related art searching method illustrated in FIGS. 1A and 1B, the REW and FF functions of a related art digital image reproducing apparatus operate to sequentially decode the key frames and the decoded key frames are output onto a screen. The related art digital image reproducing apparatus can decode the key frames sequentially, or periodically. In addition, the digital image reproducing apparatus can change the intervals between the key frames that are decoded by using a deceleration or an acceleration function.

FIG. 1A shows an operation of searching the digital video images to an initial frame (frame 0) and then reproducing the digital video. The related art digital image reproducing apparatus does not search the digital video images to the very initial frame. Rather, the related art digital image reproducing apparatus searches the digital video images to an appropriate initial point (a few seconds prior to the initial point) during the REW operation, stops the REW operation, and then plays the digital video from the initial point or waits for input of a user's selection from a video list screen or menu. For example, the search can be performed to frame 5 of FIG. 1A, and then, the digital video image can start to be played.

FIG. 1B shows an operation of searching the digital video image to frame 300, and stopping the search operation. In the related art digital image reproducing apparatus, when the forward searching process is performed, the search is not performed to the very last frame, but to an appropriate point (a few seconds prior) from the last frame. The forward searching is then stopped, and the digital video is played again from where the digital video began, a next digital video is played from the beginning, or a video list screen or menu is displayed to allow for input of a user's selection. In some digital image reproducing apparatuses, the frame near the very last frame or the last key frame is searched, and then, the digital video image is reproduced again from the point where the search operation was stopped.

However, according to the related art reverse searching process, it is difficult to stop the playing of the digital video at the very first frame in the digital video. In particular, if the user creates and edits the digital video manually, the first frame or the initial portion of the digital video is likely to have important information. When using the related art reverse searching process, in order for the user to capture the first frame or pause to perform the reproducing operation beginning with the first frame, the operation of the digital image reproducing apparatus must be paused right after the reverse searching process is performed, or must be paused right after playing of the digital video from the list screen or menu, which is nearly impossible. Thus, in order to find the image frame at the initial part of the digital video using a slow-motion function, the digital video is paused and is reproduced slowly. In addition, in order to accurately find the image frame desired by the user, the pause function must be used after reproducing the digital video at normal or slow speed. Therefore, it is difficult to find the important scenes at the initial part of the digital video according to the related art reverse search process or method.

Likewise, in the related art forward search process, it is difficult to display the very last frame which is not a key frame when the digital video is reproduced to the last part. In view of the period between the key frames, that is, a few seconds, the last frame is not likely to be the key frame. In addition, since only the key frames are decoded during the searching process, the last frame that is not the key frame cannot be decoded during the searching process.

Moreover, according to the related art digital image reproducing apparatus, the selection that can be made by a user is limited when the forward searching process is performed to the last portion of the video or to the last frame. That is, at the last frame of the video, the user may want to reproduce a next video file, re-reproduce a current video, or to search for the desired scene or time by performing the reverse search process from the last reproduced frame. However, according to the related digital image reproducing apparatus, the searching process is stopped before displaying the last frame, or the next video file is forcedly or automatically reproduced, which is inconvenient to the user. If the next video file is automatically reproduced whenever the searching process is performed at the last portion of the current video file, the user must select the just reproduced video file to be reproduced and perform the search operation carefully again in order to find the desired scene from the digital video.

Moreover, it is difficult to search the frames located after the last key frame by using the related art digital image reproducing apparatus. When the user wants to find a frame in a certain section, the user must pause at the key frames, including the last key frame, and then reproduce the video again. Even if the user stops the searching process after decoding exactly at the last key frame, a lot of image frames after the last key frame must be reproduced if the desired image frame is located far from the last key frame.

In addition, according to the related art forward searching method, it is difficult to find the desired scene again if the desired scene or time is not found due to a structural limitation of the digital image reproducing apparatus or by a mistake of the user. If the digital image reproducing apparatus reproduces the corresponding digital video or other videos automatically, or stops the reproducing of the digital video, the user might be forced to perform the forward searching process again with respect to the entire video from the beginning in order to find the last scene.

In particular, if the video having a long running time is forward searched, not all of the key frames are decoded while skipping over a few frames or using the acceleration function. In this case, the user is likely to miss the desired scene during the forward searching process, and in particular, the desired scene might not be displayed on the screen since it is not decoded. Then, the user has to perform the reverse searching process again, or perform the normal play or slow-motion play operation after the reverse search process in order to search for the desired scene. However, according to the related art digital image reproducing apparatus, if the desired scene is in the last portion of the video, the searching process can be changed into the play mode without or before the desired scene is searched, or the video list screen or menu can be displayed once the searching process stops. In addition, if the user skips the desired scene by mistake, the digital image reproducing apparatus still reproduces the digital video or stops the reproducing of the digital video without regard to the user's mistake. Accordingly, such is inconvenient to the user.

Therefore, a digital image reproducing apparatus is definitely required, by which important scenes on the initial part or the last part of the video can be easily found.

In addition, a forward/reverse search method is used that can improve convenience to the user by allowing the user to directly command post-processing of the digital image reproducing apparatus after searching the video from beginning to end.

### SUMMARY OF THE INVENTION

Aspects of the present invention provide a digital image reproducing apparatus that searches for important image frames at an initial part or last part of a digital video image.

Aspects of the present invention also provide a digital image forward searching method allowing a user of the digital image reproducing apparatus to search for image frames located after a last key frame.

Aspects of the present invention also provide a digital image reverse searching method that prevents or reduces a next digital video image from being reproduced when the user does not find a desired image frame so that the user can conveniently use the digital image reproducing apparatus.

According to an aspect of the present invention, a digital image reproducing apparatus includes: a decoder to decode digital video images; and a searching parameter setting unit to set the searching parameters used to search the decoded digital video images, wherein during searching, the decoder decodes an essential frame that must be decoded which was set by the searching parameter setting unit, and waits to receive a next process command from a user. The searching parameter may include a searching direction, a searching speed, a time code jump value, the essential frame that must be decoded, or combinations thereof. If the searching direction is forward, the essential frame that must be decoded may be the last frame of the digital video images. The decoder decodes a last key frame of the digital video images prior to the essential frame that must be decoded, and decodes all frames subsequent to the last key frame up to the essential frame that must be decoded. If the searching direction is forward, the essential frame that must be decoded may be the last frame in a section having continuous time codes in the digital video images. If the searching direction is forward, the essential frame that must be decoded may be the last frame in a section having the digital video images in which the time codes that are not discontinuous for longer than the time code jump value. The decoder may decode the last key frame in the section of the digital video images, and may integrally decode the frames between the key frame and the essential frame that must be decoded. If the searching direction is a reverse direction, the essential frame that must be decoded may be an earliest frame of the digital video images, and the decoder may decode a key frame that is prior to the essential frame that must be decoded, and integrally decodes all frames between the key frame and the essential frame that must be decoded. The next process may be one of stopping reproduction of the digital video images, forward searching, reverse searching, reproducing of current digital video images, reproducing of next digital video images, and capturing the decoded digital video images.

According to another aspect of the present invention, a digital image forward searching method includes: setting a searching parameter which is used to search the digital video images; and decoding the digital video images forwardly according to the set searching parameter during a search, wherein the decoding of the digital video images may include: decoding an essential frame that must be decoded, and waiting to receive a next process command from a user. The decoding of the digital video images may further include: decoding a last key frame of the digital video images, and decoding all frames behind the last key frame. The key frame may be the first key frame of the digital video images. The next process may be one of stopping reproducing of the digital video images, forward searching, reverse searching, reproducing of current digital video images, reproducing of next digital video images, and capturing the decoded digital video images.

According to another aspect of the present invention, a digital image reverse searching method includes: setting a searching parameter which is used to search the digital video images; and decoding the digital video images in a reverse direction according to the set searching parameter during a search, wherein the decoding of the digital video images may include: decoding an essential frame that must be decoded; and waiting to receive a next process command from a user. The searching parameter may include a searching direction, a searching speed, a time code jump value, the essential frame that must be decoded, or combinations thereof. The essential frame that must be decoded may be a last frame of the digital video images. The decoding of the digital video images may further include: decoding a key frame located prior to the essential frame that must be decoded; and decoding all frames between the key frame and the essential frame that must be decoded. The essential frame that must be decoded may be the last frame in a section having continuous time code. The essential frame that must be decoded may be the last frame in a section having the digital video images in which the time codes that are not discontinuous for longer than the time code jump value. The decoding of the digital video images may further include: decoding the last key frame in the section of the digital video images located subsequent to the essential frame that must be decoded, and decoding all frames between the last key frame and the essential frame that must be decoded.

According to another aspect of the present invention, the user can search for the first frame to the last frame in the digital image, and can prevent the next process from operating if the user does not want to operate the next process after searching for the first frame to the last frame of the digital image.

According to another aspect of the present invention, a method to search digital video images includes setting a searching parameter to search the digital video images, setting at least one essential frame that must be decoded that is mandatorily decoded from among frames of the digital video images, searching the digital video images by decoding some of the frames of the digital video images in a first direction according to the set searching parameter up to the set essential frame that must be decoded during the search, and pausing to receive a next process command from a user.

According to another aspect of the present invention, a computer readable medium recorded with a program for a computer to execute a method to search digital video images, wherein the computer executes the method.

According to an aspect of the present invention, a digital image reproducing apparatus includes a control unit to set a searching parameter to search the digital video images, set at least one essential frame that must be decoded that is mandatorily decoded from among frames of the digital video images, search the digital video images by decoding some of the frames of the digital video images in a first direction according to the set searching parameter up to the set essential frame that must be decoded during a search, pause to receive a next process command from a user, and a video output to output the decoded frames and the set essential frame that must be decoded during the search.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1A is a diagram illustrating a related art digital image forward searching method;

FIG. 1B is a diagram illustrating a related art digital image reverse searching method;

FIG. 2 is a block diagram of a digital image reproducing apparatus according to an aspect of the present invention;

FIGS. 3A-3B are diagrams illustrating a digital image reverse searching method according to an aspect of the present invention;

FIGS. 4A-4C are diagrams illustrating a digital image forward searching method according to an aspect of the present invention;

FIG. 5 is a flowchart illustrating a digital image forward searching method according to an aspect of the present invention; and

FIG. 6 is a flowchart illustrating a digital image reverse searching method according to an aspect of the present invention.

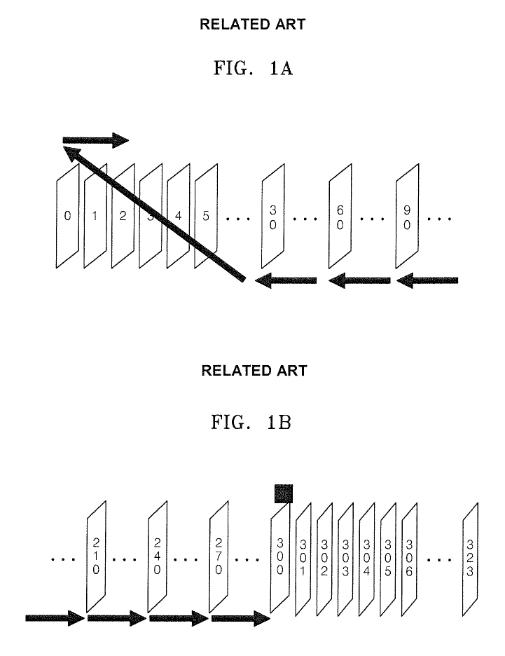

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

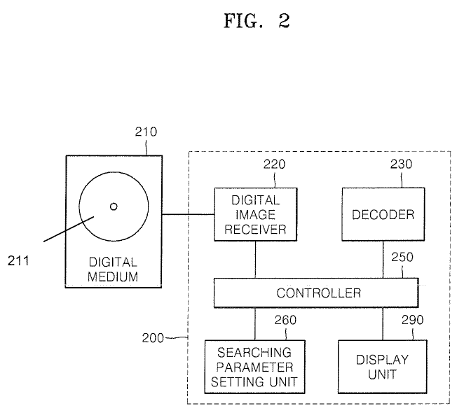

FIG. 2 is a block diagram of a digital image reproducing apparatus 200 according to an aspect of the present invention. The digital image reproducing apparatus 200 includes a digital image receiver 220, a decoder 230, a controller 250, a search (or searching) parameter setting unit 260, a display unit 290. The digital image receiver 220 reads digital image signals from a digital medium 211 loaded on a tray 210. In the aspect illustrated in FIG. 2, digital image signals are read from the medium such as a disc 211 loaded on the tray 210. However, aspects of the present invention are not limited thereto, and the digital image signals can be read from various media such as a hard disc or a memory card (not shown). Moreover, it is understood that the apparatus 200 can include a recording function in addition to the reproducing function.

The digital image signals are decoded by the decoder 230, and transmitted to the display unit 290. In a forward or reverse searching process, components of the digital image reproducing apparatus 200 reads key frames of digital image or digital images of the digital medium and provides the display unit 290 with the key frames. The display unit 290 displays the decoded digital images. While the display unit 290 is shown as part of the apparatus, the display unit 290 may be connected to the digital image reproducing apparatus 200.

The searching parameter setting unit 260 sets various conditions used to search the digital images. For example, the searching parameters can include a searching direction, a searching speed, a time code jump value, essential frames that must be decoded, and/or others. The searching direction parameter is used to determine whether the forward searching process or the reverse searching process will be performed. The searching speed parameter, for example, ×2, ×4, or ×16 (or higher speeds or speeds in-between), determines the speed used in the searching process. The essential frames that must be decoded are frames that must be (or mandatorily be) decoded during the searching process and can be set to key frames, or non-key frames. In various aspects, the time code jump value (or desired interval jump value) is used to distinguish sections, which are units subject to the searching process in the digital video image. In various aspects, the user would expect the last frame to be displayed even if the last frame is not a key frame during a forward searching process because the last frame of the digital video image may include important information. In this case, the user can set the last frame of the digital video image as an essential frame that must be decoded. Otherwise, the user can set the frame that is about 0.5 second prior to the last frame as the essential frame that must be decoded. In this case, even if a fade-out effect is added within the last 0.5 second of the digital video image, the user can set the frames to decode before the fade-out effect begins. As noted above, the time code jump value is used to distinguish sections that are units subject to the searching process in the digital video image. The time code jump value will now be described in detail.

For convenience of explanation, it is assumed that the user generates a digital image using a digital camcorder. In various aspects, any multimedia digital file may be generated, such as an MPEG 4 file, for example, using a variety of devices. The digital camcorder encodes the image that is input through a lens of the digital camcorder and adds a time code to store the input image as a digital image when the user starts shooting the image. When the user pauses recording and then re-starts shooting (or recording) of the image, the digital video image is generated from a time point when the shooting is restarted. When the digital video image is generated, the user can capture and store the digital video image.

In this case, the digital video image from a point at which the user starts to capture images, to a point at which the user stops the capturing, can be stored as one digital video image file regardless of whether the digital video images are continuously generated (shot) or not. For example, the user may create a digital video image of the birthday party of the user's child. The user can record all of the party from the beginning to the end, or alternatively, the user can selectively record only important parts of the party. In the latter case, the time code of the generated digital video image is not continuous. In addition, the user may record a Christmas party a few days later after the child's birthday party, and the user may store the digital video images of the birthday party and the Christmas party as one digital video image file.

Then, when the user wants to search for important (or desired) frames from the created digital video images, the desired frames can be found in the digital video images of the birthday party and/or in the digital video images of the Christmas party. In this case, the user can regard the digital image of the birthday party as a section, and the digital video image of the Christmas party as another section. If so, the two sections may be distinguished from each other using the time code jump value. For example, the user can set the time code jump value to be 10 minutes. Then, even if the user pauses during recording of the birthday party, the digital image reproducing apparatus 200 regards the digital video image files as one section as long as the time code is not discontinuous for 10 minutes or longer. Therefore, even if the user pauses a plurality of times while recording the birthday party, the digital image reproducing apparatus 200 can regard the entire digital video images of the birthday party as one section, and not regard the digital video images between the pauses as separate sections. Accordingly, since the digital video image of the Christmas party is recorded a few days after the birthday party, the time codes of the two digital video images would be different by more than 10 minutes. Therefore, the digital image reproducing apparatus 200 can automatically divide the digital video images of the Christmas party as a different section from the digital video images of the birthday party.

As described above, when the digital video image is divided into two sections or more sections, the user can search the important frames according to the section units. The searching process will now be described in detail below.

If the user starts the forward searching process in the birthday party section, for example, key frames at predetermined intervals are decoded by the decoder 230 according to the searching speed set by the user. As shown, when the user sets the last frame of the birthday party section as the essential frame that must be decoded, the digital image reproducing apparatus 200 operates as follows. While not required, the user can set the essential frame that must be decoded using the digital image reproducing apparatus 200, or through a separate device, such as a recording apparatus, digital camcorder, editing device (etc.). Once set, the digital image reproducing apparatus 200 detects the set essential frame that must be decoded or frames for each sector prior to searching.

1) If the essential frame that must be decoded is the key frame, the digital image reproducing apparatus 200 decodes the key frames until it reaches the essential frame that must be decoded, stops the decoding operation, and waits for a next operation.

2) If the essential frame that must be decoded is not a key frame, the digital image reproducing apparatus 200 decodes the key frames until it reaches the key frame that is located prior to the essential frame that must be decoded. Thereafter, the digital image reproducing apparatus 200 decodes all frames located between the last decoded key frame and the essential frame that must be decoded, and provides the display unit 290 with all of the decoded frames subsequent to the last decoded key frame. Once the essential frame that must be decoded is decoded, the digital image reproducing apparatus 200 may wait for the user command for the next operation.

Once one of the above two operations are complete, the user can operate the digital image reproducing apparatus 200 to display the frames that are behind (or subsequent to) the displayed key frame in one frame unit increments, restart the forward searching process from the beginning of the digital video image, or reproduce the digital video image at a normal speed after (or subsequent to) the key frame. By way of the above, the digital image reproducing apparatus 200 does not automatically reproduce the next section, namely, the next Christmas party section, but rather, waits for the user's next command after displaying the last frame of the birthday party section. Therefore, the user can prevent the searching process from proceeding to the next section which does not include the frame desired by the user. Thus, the user can use the digital image reproducing apparatus 200 in a convenient manner. When the user finds the desired frame from the birthday party section, the user can perform the next process, for example, capturing the desired frame.

As described above, the digital image reproducing apparatus 200 illustrated in FIG. 2 can display the digital video image up to the last frame even if the last frame of the predetermined section is not the key frame during the forward searching process. In addition, the frames behind (or subsequent to) the last key frame are decoded in a single process and provided to the display unit, to thereby improve the searching speed by use of the essential frame that must be decoded or designation of a frame as the essential frame that must be decoded.

A reverse searching method (or process) of the digital image reproducing apparatus 200 will now be described. As in the forward searching method (or process), the searching parameters are used in the reverse searching process. For example, the user can set a first frame in one section as the essential frame that must be decoded. The first frame within a section is generally a key frame, which is unlike a last frame of the section. Accordingly, the digital image reproducing apparatus 200 may proceed with performing the reverse searching process to the essential frame that must be decoded according to the predetermined searching speed and pause after displaying the essential frame that must be decoded. Then, the user can freely set the next process so that the user can proceed with a forward searching process, stop the searching process, or reproduce the section at normal speed. As in the forward searching process, the reverse searching process is performed within the same section, so the user can easily find the desired frame.

According to an aspect of the present invention, the section refers to a range, in which the searching process is performed, and in various aspects, the entire digital video image can be a single section.

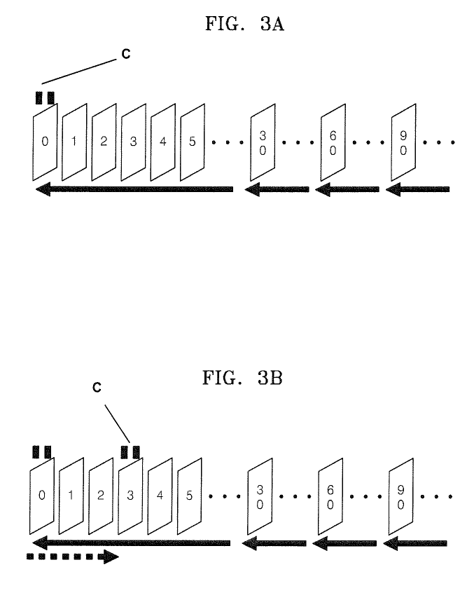

FIGS. 3A-3B are diagrams illustrating a digital image reverse searching method according to an aspect of the present invention. In FIGS. 3A and 3B, it is assumed that frames 0, 30, 60, and 90 are the key frames, by way of example. Referring to FIG. 3A, when the reverse searching process starts, the digital image reproducing apparatus 200 decodes and displays the key frames in the order of frame 90, frame 60, frame 30, and frame 0. The frame 0 is the first frame of the digital video images, and the first frame in the section of the digital video image of FIGS. 3A and 3B. In addition, it is assumed that the user sets the first frame 0 as the essential frame that must be decoded C.

As shown in FIG. 3A, the digital image reproducing apparatus 200 displays the digital video image up to frame 0, and pauses. In FIG. 3(a), ‘∥’ mark represents the pause state. When the digital image reproducing apparatus 200 pauses at the frame 0, the user can command the next process such as stop reproducing, forward search, and reproduce the current digital video image. After displaying the frame 0, the user can search the frames behind (or subsequent to) the frame 0 by frame units increment (i.e., by one frame unit or by each frame increments). The digital image reproducing apparatus 200 waits for the next command of the user after decoding the digital video image up to the very first frame during the reverse searching process. Therefore, the user can conveniently use the digital image reproducing apparatus.

FIG. 3B shows a case where the very first frame is not the essential frame that must be decoded. For convenience of explanation, it is assumed that the user sets a frame that is located 0.5 second later than the first frame as the essential frame that must be decoded C, and the essential frame that must be decoded C is the frame 3, by way of example. When the user sets frame 3 as the essential frame that must be decoded C, the user is able to mandate display of a frame occurring after the finish of a fade-in effect. The above assumption is for convenience of explanation, and the aspects of the present invention are not limited thereto.

Referring to FIG. 3B, the digital image reproducing apparatus 200 decodes and displays the digital video images up to the frame 0 that is the key frame located prior to the essential frame that must be decoded in order to display the frame 3 (which is the essential frame that must be decoded C). In addition, all frames between the frame 0 and the first key frame (frame 30) behind (or subsequent to) the frame 0 are integrally decoded (or decoded in a single process). When the decoding of frames 0-30 is finished, the digital image reproducing apparatus 200 displays the frame 3 to the user. The user starts the searching process from the frame 0 to the frame 3, and then, pauses. If the frame 3 is the desired frame, the user can perform the post process such as capturing the frame 3.

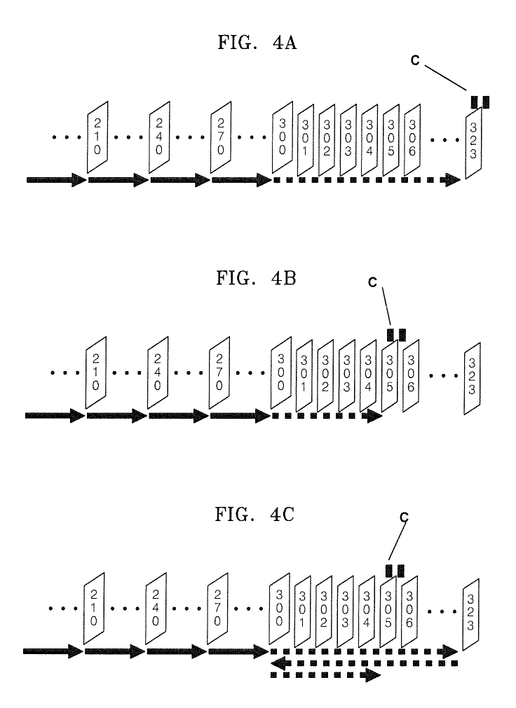

FIGS. 4A-4C are diagrams illustrating a digital image forward searching method according to an aspect of the present invention. In FIGS. 4A-4C, it is assumed that frames 210, 240, 270, and 300 are key frames. In FIG. 4A, when the user wants to find the last frame (frame 323), the digital image reproducing apparatus 200 sequentially decodes the frames 210, 240, and 270 and displays the decoded frames. When the searching speed becomes faster, only some of the key frames can be decoded as described above. In addition, the digital image reproducing apparatus 200 can decode one or more key frames having (or located at) a predetermined interval as described above. FIG. 4A shows a case where the last frame (frame 323) is the essential frame that must be decoded C. The digital image reproducing apparatus 200 decodes the digital video image up to the frame 300 that is the last key frame before the frame 323, and decodes all frames between the frame 300 and the essential frame that must be decoded C (frame 323) in a single process (i.e., between set key frame and a selected essential frame that must be decoded). In addition, the digital video image reproducing apparatus 200 displays the decoded frame 323, and pauses.

FIG. 4B shows a case where the user sets the frame 305 as the essential frame that must be decoded C. As in FIG. 4A, the digital image reproducing apparatus 200 decodes the frame 300 that is the key frame that is located or occurs prior to the essential frame that must be decoded C (frame 305), and decodes the frames up to the frame 305 in a single process. Then, the digital image reproducing apparatus 200 displays the frame 305, and pauses.

FIG. 4C shows a case where the user does not stop the forward searching process at the frame 305, but performs the forward searching process continuously. If the user keeps performing the forward searching process, the digital image reproducing apparatus 200 pauses at the frame 323, that is, the last frame of the section. Therefore, the user can perform the reverse searching process from the frame 323 without continuing to reproduce the next section beyond frame 323. The user can reach the frame 305 using a slow-motion playing speed, regular playing speed, or fast forward (FF) function after performing the reverse searching process from the frame 323.

Referring to FIGS. 4A-4C, the digital image reproducing apparatus 200 according to an aspect of the present invention changes the mode thereof into the pause mode automatically when the searching operation reaches the essential frame that must be decoded C, so that the user can subsequently have a variety of selections choices. That is, the user can reproduce the previous, current, or next digital video image, or can find the desired scene and time by adjusting the various operations such as the FF, slow-motion play, or double speed play. Moreover, according to the digital image reproducing apparatus 200 according to aspects of the present invention, the searching process is performed only in one section. Accordingly, the user can perform the searching operation again if the user cannot find the desired scene during a first pass thereof.

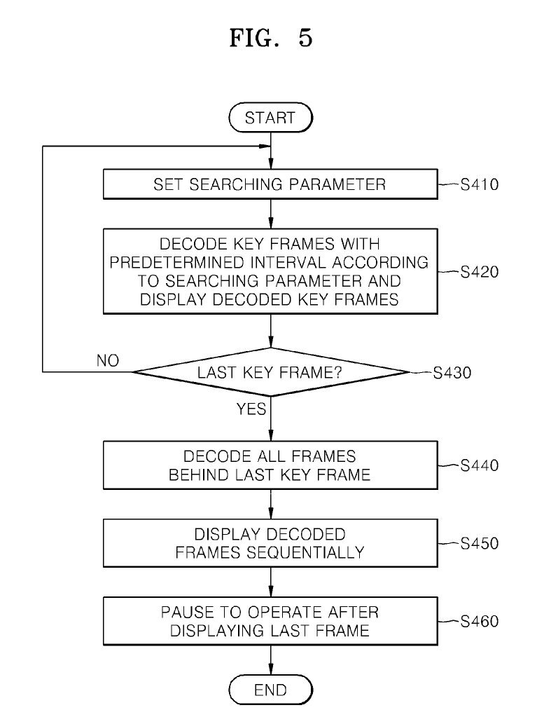

FIG. 5 is a flowchart illustrating a digital image reverse searching method according to an aspect of the present invention. First, the searching parameters are set (operation S410). As described above, the searching parameters can include the searching direction, the searching speed, the time code jump value, and/or the essential frame that must be decoded.

Once the searching parameters are set, the key frames are sequentially decoded according to the set searching speed and are displayed (operation S420). When the searching speed increases, the interval between the essential frame to be decoded key frames are also increased.

If the essential frame that must be decoded is the last frame, it is determined whether the last key frame has been decoded or not (operation S430). The last key frame is required to decode the last frame, because, all of the frames behind (or subsequent to) the last key frame are integrally decoded (or decoded in a single process) (operation S440), and the decoded frames are sequentially displayed (operation S450). Otherwise, the last frame, which in this case is the essential frame that must be decoded, can be displayed from among the decoded frames. When the last frame C (that is, the essential frame that must be decoded) is displayed, the digital image reproducing apparatus 200 pauses (operation S460) and waits for the next operation (or input command) of the user. In FIG. 5, the essential frame that must be decoded is the last frame, however, such is not required, and the essential frame that must be decoded may be any one of the frames that is located prior to the last frame.

As shown in FIG. 5, according to the digital image forward searching method according to an aspect of the present invention, the essential frame that must be decoded that is not the key frame can be displayed, and the digital image reproducing apparatus is paused after displaying the essential frame that must be decoded. Therefore, convenience to the user can be improved or increased.

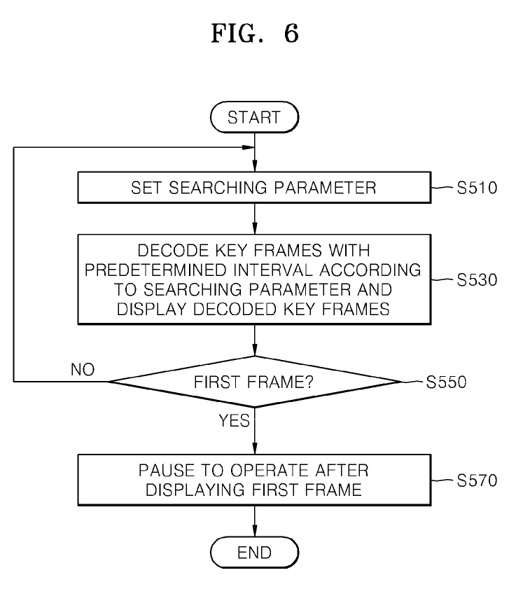

FIG. 6 is a flowchart illustrating a digital image reverse searching method according to an aspect of the present invention. As was similarly described above with reference to FIG. 5, the searching parameters are also set (operation S510) in the reverse searching method shown in FIG. 6. When the searching parameters are set, the key frames are sequentially decoded and displayed according to the set searching parameter (operation S530). In the aspect shown, the set searching parameter may be a searching speed.

In FIG. 6, the essential frame that must be decoded is the first frame. Accordingly, once the searching parameter is set, it is determined whether the key frame is the first frame (operation S550). If the key frame is the first frame, the decoded first frame is displayed and the operation is paused (operation S570). On the other hand, if the essential frame that must be decoded is not the first frame, the frames are decoded up to the key frame that is located prior to the essential frame that must be decoded, and subsequently, all frames between the decoded key frame and the essential frame that must be decoded are integrally decoded (or decoded in a single process). Thus, the decoded essential frame that must be decoded can be displayed.

As shown in FIG. 6, according to the digital image reverse searching method of an aspect of the present invention, the essential frame that must be decoded that is not the key frame can be displayed, as well as the key frame. In addition, the searching process is performed in a predetermined section. Accordingly, the user can perform the searching process conveniently.

According to aspects of the present invention, the frame that is not the key frame can be decoded and displayed in the digital image forward/reverse searching processes.

In addition, the last frame including an important scene can be displayed during the forward searching process, and the operation of the digital image reproducing apparatus is automatically paused when the searching reaches the last frame so as to allow the user to select one of various operations such as reproducing of the previous, current, or next digital video image, and performing the reverse searching from the last frame.

Moreover, since the searching process is performed in a predetermined section, a desired image can be easily found in a digital image having a long running time. In addition, if the user cannot find the desired scene, the searching process can be easily performed again.

In various aspects, the time and/or number of interval between key frames are variable based on the search speed. Also, in various aspects, the essential frame that must be decoded may or may not be designated, as any of the frames of the digital images. Also, in various aspects, there may be more than one essential frame that must be decoded so that a search may occur between at least two essential frames that must be decoded, in the forward and/or reverse directions. In various aspects, the digital image receiver 220, the decoder 230, the controller 250, and/or the search (or searching) parameter setting unit 260 may be implemented by a single control unit. In various aspects, image, images, video, digital video, and digital video image(s) may be interchangeable. In various aspects, display of the decoded frames is not required.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A digital image reproducing apparatus comprising:
a decoder to decode digital video images; and
a searching parameter setting unit to set searching parameters used to search the decoded digital video images,
wherein, during searching, the decoder decodes an essential frame that must be decoded which was set by the searching parameter setting unit, and waits to receive a next process command from a user.

2. The digital image reproducing apparatus of claim 1, wherein the searching parameter includes a searching direction, a searching speed, a time code jump value, the essential frame that must be decoded, or combinations thereof.

3. The digital image reproducing apparatus of claim 2, wherein if the searching direction is forward, the essential frame that must be decoded is a last frame of the digital video images.

4. The digital image reproducing apparatus of claim 3, wherein the decoder decodes a last key frame of the digital video images prior to the essential frame that must be decoded, and decodes all frames subsequent to the last key frame up to the essential frame that must be decoded.

5. The digital image reproducing apparatus of claim 2, wherein if the searching direction is forward, the essential frame that must be decoded is a last frame in a section having continuous time codes in the digital video images.

6. The digital image reproducing apparatus of claim 2, wherein if the searching direction is forward, the essential frame that must be decoded is a last frame in a section having the digital video images in which the time codes that are not discontinuous for longer than the time code jump value.

7. The digital image reproducing apparatus of claim 5, wherein the decoder decodes the last key frame in the section of the digital video images, and integrally decodes the frames between the key frame and the essential frame that must be decoded.

8. The digital image reproducing apparatus of claim 2, wherein if the searching direction is a reverse direction, the essential frame that must be decoded is an earliest frame of the digital video images.

9. The digital image reproducing apparatus of claim 2, wherein if the searching direction is a reverse direction, the decoder decodes a key frame that is prior to the essential frame that must be decoded, and integrally decodes all frames between the key frame and the essential frame that must be decoded.

10. The digital image reproducing apparatus of claim 9, wherein the key frame is the first key frame of the digital video images.

11. The digital image reproducing apparatus of claim 1, wherein the next process is one of stopping reproduction of the digital video images, forward searching of the digital video images, reverse searching of the digital video images, reproducing of current digital video images, reproducing of next digital video images, and/or capturing the decoded digital video images.

12. A digital image forward searching method comprising:
setting a searching parameter which is used to search digital video images; and
decoding the digital video images forwardly according to the set searching parameter during a search,
wherein the decoding of the digital video images comprises:
decoding an essential frame that must be decoded and
waiting to receive a next process command from a user.

13. The method of claim 12, wherein the searching parameter includes a searching direction, a searching speed, a time code jump value, the essential frame that must be decoded, or combinations thereof.

14. The method of claim 13, wherein the essential frame that must be decoded is a last frame of the digital video images.

15. The method of claim 14, wherein the decoding of the digital video images further comprises:
decoding a last key frame of the digital video images located prior to the essential frame that must be decoded, and decoding all frames subsequent to the last key frame up to the essential frame that must be decoded.

16. The method of claim 13, wherein the essential frame that must be decoded is a last frame in a section having continuous time codes in the digital video images.

17. The method of claim 13, wherein the essential frame that must be decoded is the last frame in a section having the digital video images in which the time codes that are not discontinuous for longer than the time code jump value.

18. The method of claim 16, wherein the decoding of the digital video images further comprises:
decoding a last key frame in the section of the digital video images located prior to the essential frame that must be decoded, and decoding all frames between the last key frame and the essential frame that must be decoded.

19. A digital image reverse searching method comprising:
setting a searching parameter which is used to search the digital video images; and
decoding the digital video images in a reverse direction according to the set searching parameter during a search, wherein the decoding of the digital video images comprises:
decoding an essential frame that must be decoded, and
waiting to receive a next process command from a user.

20. The method of claim 19, wherein the decoding of the digital video images further comprises:
decoding a key frame located prior to the essential frame that must be decoded; and
decoding all frames between the key frame and the essential frame that must be decoded.

21. The method of claim 20, wherein the key frame is an earliest key frame in the digital video images.

22. The method of claim 12, wherein the next process is stopping reproducing of the digital video images, forward searching, reverse searching, reproducing of current digital video images, reproducing of previous digital video images, reproducing of next digital video images, and/or capturing the decoded digital video images.

23. The digital image reproducing apparatus of claim 6, wherein the decoder decodes a last key frame in the section of the digital video images, and integrally decodes the frames between the last key frame and the essential frame that must be decoded.

24. The method of claim 17, wherein the decoding of the digital video images further comprises:
decoding a last key frame in the section of the digital video images located subsequent to the essential frame that must be decoded, and decoding all frames between the last key frame and the essential frame that must be decoded.

25. The method of claim 19, wherein the next process is stopping reproducing of the digital video images, forward searching, reverse searching, reproducing of current digital video images, reproducing of previous digital video images, reproducing of next digital video images, and/or capturing the decoded digital video images.

26. A method to search digital video images comprising:
setting a searching parameter to search the digital video images;
setting at least one essential frame that must be decoded that is mandatorily decoded from among frames of the digital video images;
searching the digital video images by decoding some of the frames of the digital video images in a first direction according to the set searching parameter up to the set essential frame that must be decoded; and
pausing to receive a next process command from a user.

27. The method of claim 26, wherein key frames are located at regular intervals of the digital video images, and non-key frames between the essential frame that must be decoded and a closest key frame thereto which require the closest key frame for decoding, are also decoded.

28. The method of claim 26, wherein the essential frame that must be decoded is selectable to be the key frame and the non-key frame.

29. The method of claim 26, wherein the essential frame that must be decoded is a very last frame of the digital video images and the first direction is a forward direction.

30. The method of claim 26, wherein the essential frame that must be decoded is a very first frame of the digital video images and the first direction is a reverse direction.

31. The method of claim 26, wherein the essential frame that must be decoded is neither a very last frame nor a very first frame of the digital video images.

32. A computer readable medium recorded with a program for a computer to execute a method to search digital video images, wherein the computer executes the method of claim 26.

33. A digital image reproducing apparatus comprising:
a control unit to set a searching parameter to search the digital video images, set at least one essential frame that must be decoded that is mandatorily decoded from among frames of the digital video images, search the digital video images by decoding some of the frames of the digital video images in a first direction according to the set searching parameter up to the set essential frame that must be decoded during a search, and pause to receive a next process command from a user; and
a video output to output the decoded frames and the set essential frame that must be decoded during the search.

34. The apparatus of claim 33, wherein key frames are located at regular intervals of the digital video images, and non-key frames between the essential frame that must be decoded and a closest key frame thereto which require the closest key frame for decoding, are also decoded.

35. The apparatus of claim 33, wherein the essential frame that must be decoded is selectable to be the key frame and the non-key frame.
